(19) United States
(12) Patent Application Publication
(10) Pub. No.: US 2019/0238455 A1
(43) Pub. Date: Aug. 1, 2019

(54) MULTIPATH ADJUSTMENTS

(71) Applicant: Hewlett Packard Enterprise Development LP, Houston, TX (US)

(72) Inventors: Mario Sanchez, Campbell, CA (US); Kunal Mahajan, Palo Alto, CA (US); Puneet Sharma, Palo Alto, CA (US)

(21) Appl. No.: 15/885,192

(22) Filed: Jan. 31, 2018

(51) Int. Cl. H04L 12/721; H04L 12/751; H04L 12/26; H04L 12/707; H04L 12/803

(52) U.S. Cl. CPC H04L 45/38; H04L 45/02; H04L 47/122; H04L 45/22; H04L 45/24; H04L 43/0882

(57) ABSTRACT

An example network controller including: a processing resource; and a memory resource storing machine readable instructions to cause the processing resource to adjust, responsive to a factor whose corresponding value is independent of a traffic state of a particular data path, an availability of the particular data path between two of the plurality of static nodes such that the plurality of static nodes are allowed to communicate within a network via the particular data path made available.

### BACKGROUND

Data networks route data traffic via a collection of network devices that take the form of, for example, routers, hubs and switches. Very large networks may involve hundreds or even thousands of network devices such as switches, routers, access points, telecommunications towers, gateways, client devices, etc.

### BRIEF DESCRIPTION OF THE DRAWINGS

FIG. 1 illustrates an example network layout according to the disclosure.

FIG. 2 is a block diagram of an example network controller for adjusting an availability of a data path according to the disclosure.

FIG. 3 is a block diagram of an example network device for adjusting an availability of a data path according to the disclosure.

FIG. 4 is a block diagram of an example system consistent with the disclosure.

FIG. 5 is an example network illustrating communication among nodes according to the disclosure.

### DETAILED DESCRIPTION

Data networks route data traffic via a collection of network devices that take the form of, for example, routers, hubs and switches. Very large networks may involve hundreds or even thousands of network devices. To transfer data within networks, individual network devices often coordinate via network protocols to route data along paths between network devices.

Network protocols may include Transmission Control Protocol (TCP), Internet Protocol (IP), Hypertext Transfer Protocol (HTTP), File Transfer Protocol (FTP), Border Gateway Protocol (BGP), and Dynamic Host Configuration Protocol (DHCP). Some network protocols may be a multipath protocol that utilizes multiple data paths in transmitting data from one end node (e.g., source node) to another end node (e.g., destination node). For example, the TCP that utilizes multipath for transmitting data from a source node to a destination node may be referred to as Multipath TCP (MPTCP). By utilizing multiple paths, the multipath protocol may increase (e.g., MPTCP) throughput, theoretically, to a sum of throughput of available data paths. However, the multipath protocol adds complexity in controlling multiple paths, which may result in overutilization/underutilization of data paths.

Accordingly, the disclosure is directed to multipath adjustments that reduces complexity and prevents overutilization/underutilization of data paths. A network controller suitable for multipath adjustments may include a memory resource, and a processing resource to execute executable instructions stored in the memory resource. For example, the processor can execute executable instructions stored in the memory resource to cause the processing resource to adjust, responsive to a factor whose corresponding value is independent of a traffic state of a particular data path, an availability of the particular data path between two of the plurality of static nodes such that the plurality of static nodes are allowed to communicate within a network via the particular data path made available.

As used herein, “data” and “data packet” may be used interchangeably herein and may have the same meaning. For example, “data” and “data packet” may refer to a form of data that is suitable for being transmitted via a particular type of channel communication (e.g., WiFi, LTE, and/or Bluetooth).

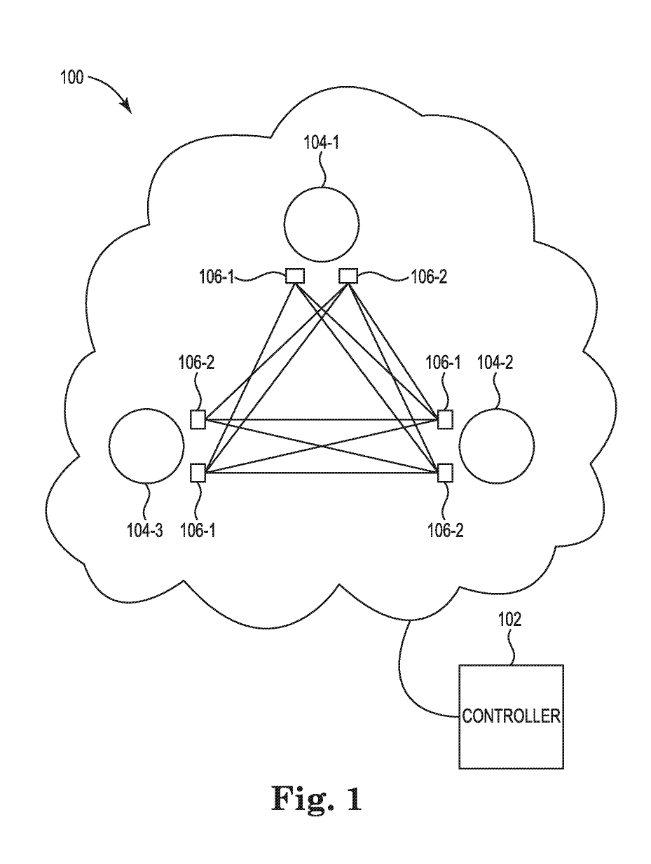

FIG. 1 illustrates an example network layout 100 according to the disclosure. As illustrated in FIG. 1, the network layout 100 can include a network controller 102, and nodes 104-1, 104-2, and 104-3 (e.g., collectively referred to as nodes104). Although three nodes are illustrated in FIG. 1, network 100 is not limited to a particular number of nodes.

Network 100 may be a wireless local area network (WLAN), a wide area network (WAN), an enterprise private network, and/or a virtual private network (VPN), or combination thereof. Network 100 further can be a software-defined network (SDN), which is a network architecture in which network control plane and policies are decoupled from network infrastructure and client devices and placed in, for example, the network controller 102. For example, network 100 can be SDN version of a WAN that can be SDWAN.

As used herein, a node may be referred to as a device and/or a data point. For example, a node can be, for example, an access point, gateway, firewall, load balancer, modem, hub, bridge, switch, host device, client device, router, workstation, and/or a server. A node can serve as a redistribution point and/or a communication endpoint of the network 100. For example, a node, as a communication endpoint can send data as a source node and/or receive data as a destination node. For example, a node, as a redistribution point, can forward received data to another node.

Nodes 104 may be static within a network. That is, static nodes 104 may remain discoverable within the network 100, for example, by controller. As such, data paths among static nodes 104 may be adjustable at any time controller 102 is willing to.

Nodes 104 may include interfaces (e.g., physical interfaces) 106 via which each node is coupled to each other. For example, each node may include interfaces 106-1 and 106-2 (e.g., collectively referred to as interfaces 106) such that each interface (e.g., 106-1 or 106-2) of one node (e.g., nodes 104) may be coupled to interfaces 106 of other nodes. As illustrated in FIG. 1, for example, each interface (e.g., 106-1 or 106-2) of node 104-1 is coupled to interfaces 106 of node 104-2; thereby, establishing four different data paths between node 104-1 and node 104-2. Similarly, each interface (e.g., 106-1 or 106-2) of node 104-2 is coupled to interfaces 106 of node 104-3, and each interface (e.g., 106-2 or 106-2) of node 104-3 is coupled to interfaces 106 of node 104-1. As such, there are four different data paths established between node 104-1 and node 104-2, between node 104-2 and node 104-3, and between node 104-1 and node 104-3. As such, network 100 may be a full mesh in which each node is coupled to all other nodes 104.

As used herein, a full mesh may be referred to as a network topology, in which every components, devices, and/or nodes are connected to every other components, devices, and/or nodes. For example, node 104-1 is connected to nodes 104-2 and 104-3, node 104-2 is connected to nodes 104-1 and 104-3, and node 104-3 is connected to nodes 104-1 and 104-2. As such, every nodes 104-1, 104-2, and 104-3 are connected to every other nodes 104.

Variety types of a communication channel may be established via a corresponding interface. For example, a first interface of the interfaces 106 may be associated with establishing a wireless local area network (e.g., a WiFi network), a second interface one of the interfaces 106 may be associated with establishing a Personal Access Network (e.g., Bluetooth, Zigbee, Ultra-Wide Band (UWB), wireless USB compatible devices), and a third interface of the interfaces 106 may be associated with establishing a cellular network (e.g., a Global System for Mobile Communications (GSM), Wideband Code Dibision Multiplexing Access (WCDMA), Long-Term Evolution (LTE), Code-Division Multiple Access (CDMA2000) network). As such, nodes 104 may include less or more than two interfaces (e.g., interfaces 106) dependent on a quantity of communication channels the network 100 utilizes.

Communication among nodes 104 within network 100 may be controlled by a logically centralized controller (e.g., controller 102). As used herein, a logically centralized controller may be referred to as a controller that is responsible for controlling/managing various aspects of other components, device, and/or nodes within network (e.g., network 100), for example, including data transmission among nodes 104. For example, network controller 102 may adjust an availability of data paths among nodes 104 responsive to various factors, for example, including a factor whose corresponding value is independent of a traffic state of the data paths and/or a factor indicating the traffic state. For example, network controller 102 may limit a rate at which data (e.g., data packets) are transmitted on data paths.

Controller 102 may utilize interfaces 106 as is or utilize a virtual interface that may be based on the interfaces 106. For example, regardless a number of interfaces 106 each node may include, controller 102 may assign an individual virtual interface to each node such that, for example, an individual data path between each set of nodes is utilized for multipath adjustments. For example, regardless a number of interfaces each node may include, controller 102 may assign multiple virtual interfaces to each node such that, for example, a number of (e.g., more than one) data paths between each set of nodes are utilized for multipath adjustments.

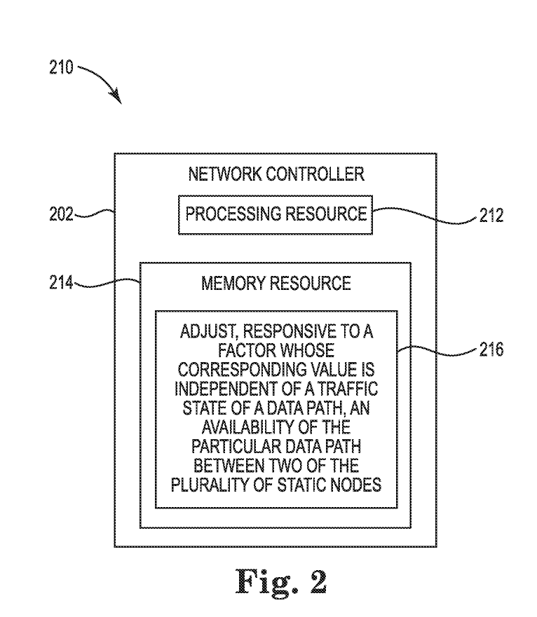

FIG. 2 is a block diagram 210 of an example network controller 202 for adjusting an availability of a data path according to the disclosure. As illustrated in FIG. 2, the network controller 202 may comprise a processing resource 212 and a memory resource 214 storing machine-readable instructions to cause the processing resource 212 to adjust an availability of a data path. Processing resource 212 may be a central processing unit (CPU), microprocessor, and/or other hardware device suitable for retrieval and execution of instructions stored in memory resource 214.

Network controller 202 may be a logically centralized controller of the SDN. Stated differently, a network (not shown) including network device 202 and nodes (not shown) may be the SDN.

Network controller 202 may include instructions 216 stored in the memory resource 214 and executable by the processing resource 212 to adjust an availability of a data path between two of static nodes. In some examples, the availability of the data path may be adjusted responsive to a factor whose corresponding value is independent of a traffic state of a data path. The factor whose corresponding value is independent of the traffic state of the data path may include, for example, a cost associated with using the data path and/or a quality of service (QoS) specification associated with the static nodes.

In some examples, the plurality of nodes whose data paths may be adjusted to be available may be static. For example, each of the plurality of static nodes is a node that is static within the network such that an availability of each of a plurality of data paths among the plurality of static nodes is, by network controller 202, adjustable at a time the network controller is willing to.

The data path made available may be utilized for communication among the plurality of static nodes. For example, the data path may be utilized as a direct and/or an indirect data path. As used herein, a direct data path may be referred to as a data path whose constituent nodes include a source node as well as a destination node. That is, by utilizing the direct data path, a data packet transmitted from the source node may be directly transmitted to the destination node, for example, without utilizing other data paths that are available within the network.

As used herein, an indirect path may be referred to as a data path whose constituent nodes include either a source node or a destination node (e.g., but not both). That is, by utilizing the indirect data path, a data packet transmitted from the source node may be transmitted to at least one intermediate node prior to being transmitted to the destination node. For example, communication between the source node and the destination node that utilizes a single intermediate node may be a 1-hop path and that utilizes two intermediate nodes may be a 2-hop path.

In some examples, a data path may be utilized as an indirect data path as well as a direct path. For example, while the data path is being utilized a direct path in transmitting existing data packet, at least one of constituent nodes of the data path may be requested by network controller 202 to act as an intermediate node for transmitting another data packet. In this event, a rate at which another data packet is transmitted via the data path can be limited by the network controller 202 such that utilization of the data path as an indirect data path does not interfere with the existing data packet. As such, utilization of a data path as a direct data path may not be affected by being utilized as an indirect data path.

In some examples, indirect data paths may be utilized to transmit data packets from a source node to a destination node while a direct path between the source node and the destination node is not utilized for the transmission. Stated differently, an availability of the direct path may also be adjusted in the same manner as an availability of the indirect data paths may be adjusted responsive to various factors including, for example, a factor indicating a traffic state of a data path and/or a factor whose corresponding value is independent of the traffic state of the data path.

In some examples, network controller 202 may limit a number of (e.g., quantity of) indirect data paths utilized in transmitting an individual data packet from a source node to a destination node. Stated differently, the network controller 202 may limit a number of (e.g., quantity of) intermediate nodes being utilized in transmitting an individual data packet from a source node to a destination node. For example, communications within a network can be performed via no more than 1-hop path. Such a limitation imposed by network controller 202 may provide benefit such as reducing complexity in multipath adjustments.

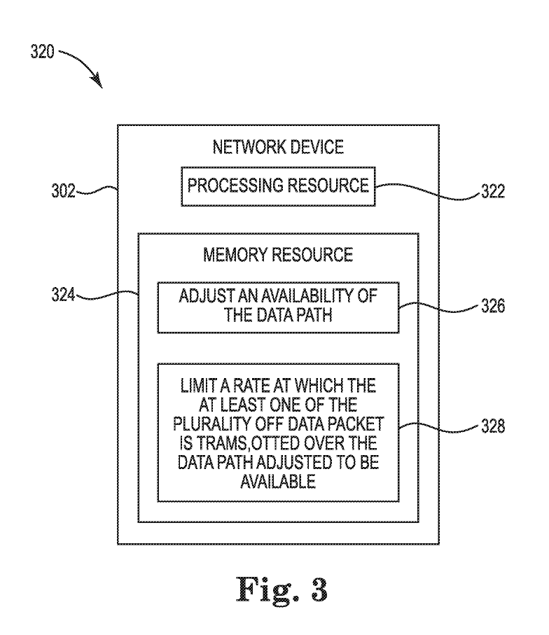

FIG. 3 is a block diagram 320 of an example network device 302 for adjusting an availability of a data path according to the disclosure. As illustrated in FIG. 3, the network device 302 may comprise a processing resource 322 and a memory resource 324 storing machine-readable instructions to cause the processing resource 322 to adjust an availability of a data path. Processing resource 322 may be a central processing unit (CPU), microprocessor, and/or other hardware device suitable for retrieval and execution of instructions stored in memory resource 324.

Network device 302 may be a logically centralized controller of the SDN. Stated differently, a network (not shown) including network device 302 and nodes (not shown) may be the SDN.

Those nodes of the network (e.g., SDN) may be static nodes. Stated differently, the static nodes of the network may physically static in the network while a logical topology associated with the network is changeable responsive to the availability of data paths within the network being adjusted. As used herein, a logical topology may be referred to as an illustration of an available data path, via which data may be transmitted, within the network. As such, those nodes that are static remain connected to each other such that an availability of at least one of the data paths among the static nodes is adjustable at any time unless a network infrastructure (e.g., controller, router, access point, etc.) associated with the network changes. This is contrary to a dynamic node (e.g., opportunistic node) that has to be detectable/discoverable within a network prior to its availability being adjustable. For example, consider a mobile user device (e.g., smartphone) that is not within a detectable distance of a particular network. In such a case, the user device is not considered to be “within” the network since the user device is not utilizable as a node of the network regardless of the network's willingness. As such, the user device may not be adjustable at any time when the user device is static within the network.

Utilization of static nodes, instead of dynamic nodes and/or a combination of static nodes and dynamic nodes, can provide benefits such as increased stability in controlling (e.g., adjusting and/or rate-limiting) data paths. For example, nodes that may be dynamically discoverable adds complexity in adjusting and determining a logical topology (e.g., among nodes) that may increase throughput to a network. In contrast, those nodes that are static within a network are assumed to be discoverable (e.g., discovered) at any time such that multipath adjustments do not involve establishing connections

Network device 302 may include instructions 326 stored in memory resource 324 and executable by processing resource 322 to adjust an availability of a data path between two static nodes in transmitting a data packet from a source static node to a destination static node.

In some examples, the availability of the particular data path may be adjusted responsive to a factor whose corresponding value is independent of a traffic state of the data path between the two static nodes. The factor whose corresponding value is independent of the traffic state of the data path may include, for example, a cost associated with using the data path and/or a quality of service (QoS) specification associated with the static nodes. These examples factors are obtainable independently from communication with static nodes in a network. For example, information of the cost associated with using a particular data path may be obtainable absent communication with the particular data path. For example, information of the QoS specification associated with the nodes may be obtainable absent communication with the static nodes. Stated differently, these information may be obtainable prior to (e.g., predeterminable) establishing communication paths (e.g., data paths) with the nodes.

In some examples, the factor (e.g., that is independent of a traffic state of a data path within a network) may further include a service-level agreement (SLA), which is an agreement to between a service provider and a client to, for example, maintain a certain level of service. The level of service to be maintained according to the SLA may include values associated with the traffic state of data paths within the network.

In some examples, network device 302 may adjust the availability of a data path responsive to, in addition to the factor whose corresponding value is independent of the traffic state of the data path, a factor indicating (e.g., associated with) a traffic state of the data path. For example, a factor indicating a traffic state of the data path may include Round-trip Delay Time (RTD), Round-Trip Time (RTT), TCP connection setup, window sizes, and packet loss via TCP sequence numbers monitoring.

Network device 302 may obtain factors described above in various ways. For example, network device 302 may actively probe nodes and/or data paths to obtain values corresponding to traffic state within a network. For example, network device 302 may passively monitor a network (e.g., nodes and/or data paths) to obtain values corresponding to traffic state within a network. In contrast, a factor whose corresponding value is independent of a traffic state of data paths may be obtainable independently from communication with nodes monitored states of data paths. For example, those factors such as the cost associated with using a data path (e.g., cost associated with using LTE), QoS, and/or SLA may be obtained from a user and/or a service provider.

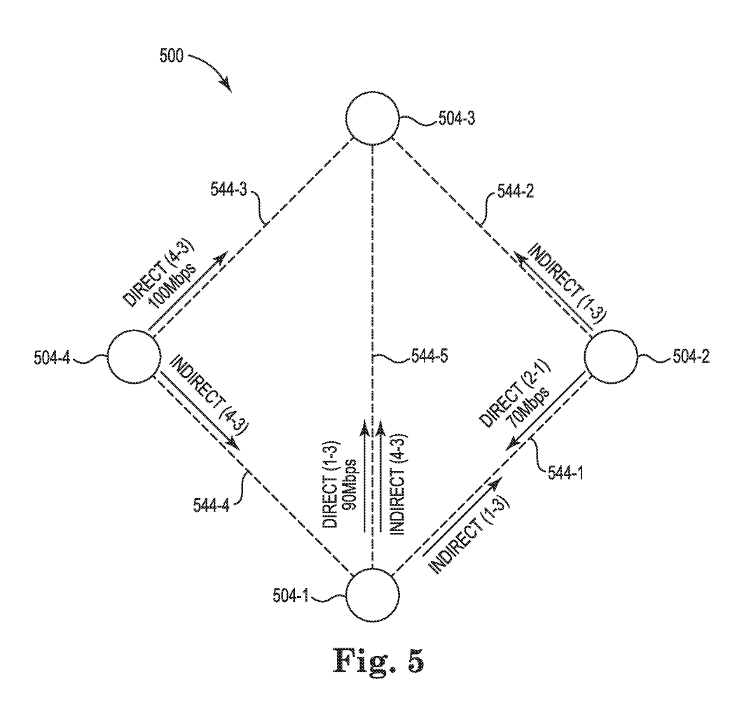

Network device 302 may include instructions 328 stored in memory resource 324 and executable by processing resource 322 to limit a rate at which at least one of the plurality of data packets is transmitted over the data path adjusted to be available such that the rate is equal to or less than a remaining capacity of the data path. As used herein, the remaining capacity of a data path may be referred to a total capacity of the data path less a capacity of the data path being utilized, as further described in connection with FIG. 5.

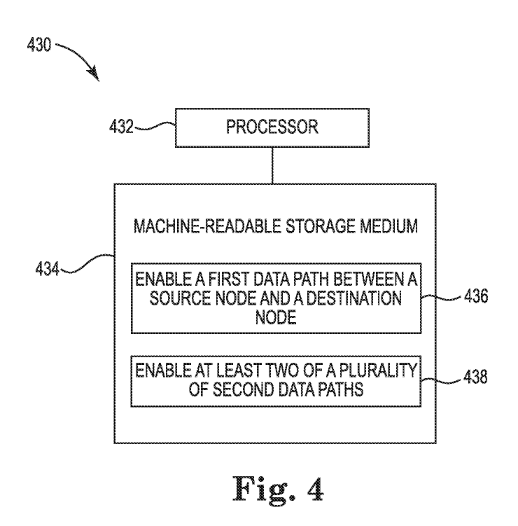

FIG. 4 is a block diagram of an example system 430 consistent with the disclosure. In the example of FIG. 4, system 430 includes a processor 432 and a non-transitory machine-readable storage medium 434. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 432 may be a central processing unit (CPU), microprocessor, and/or other hardware device suitable for retrieval and execution of instructions stored in machine-readable storage medium 434. In the particular example shown in FIG. 4, processor 432 may receive, determine, and send instructions 436 and 438. As an alternative or in addition to retrieving and executing instructions, processor 432 may include an electronic circuit comprising a number of electronic components for performing the operations of the instructions in non-transitory machine-readable storage medium 434. With respect to the executable instruction representations or boxes described and shown herein, it should be understood that part or all of the executable instructions and/or electronic circuits included within one box may be included in a different box shown in the figures or in a different box not shown.

Non-transitory machine-readable storage medium 434 may be any electronic, magnetic, optical, or other physical storage device that stores executable instructions. Thus, machine-readable storage medium 434 may be, for example, Random Access Memory (RAM), an Electrically-Erasable Programmable Read-Only Memory (EEPROM), a storage drive, an optical disc, and the like. The executable instructions may be “installed” on system 430 illustrated in FIG. 4. Non-transitory machine-readable storage medium 434 may be a portable, external or remote storage medium, for example, that allows system 430 to download the instructions from the portable/external/remote storage medium. In this situation, the executable instructions may be part of an “installation package”. As described herein, machine-readable storage medium 434 may be encoded with executable instructions for standby controllers for access points.

Instructions 436, when executed by a processor such as processor 432, may cause system 434 to enable a first data path between a source node and a destination node. The first data path may be an individual data path between the source node and the destination node. As such, the first data path may be a direct data path between the source node and the destination node.

Instructions 438, when executed by a processor such as processor 432, may cause system 430 to enable at least two second data paths. At least two data paths may be enabled responsive to a factor whose corresponding value is independent of a traffic state of each of two second data paths. The two second data paths are different than the first data path; therefore, the two second data paths are indirect data path including intermediate node(s). As such, enabled second data paths may be utilized as an indirect data paths for transmitting a data packet from the source node to the destination node.

While the first data path (e.g., direct data paths) may remain enabled for transmitting a data packet from the source node to the destination node, the second data paths (e.g., indirect data paths) may be enablable (e.g., adjustable to be available) responsive to determining that a policy associated with the factor remains non-violated. For example, a particular one of the second data paths may be enablable as long as a cost associated using the particular one of the second data paths is below a threshold cost. For example, a particular one of the second data paths may be enablable as long as a QoS associated with the particular one of the second data paths is above a threshold QoS. Stated differently, if the policy associated with the factor (e.g., whose corresponding value is independent of a traffic state of an indirect data path) is violated, the indirect data path may be prohibited from being enabled, for example, although utilizing that indirect data path would effectively increase a network throughput within a network.

FIG. 5 is an example network 500 illustrating communication among nodes 504 according to the disclosure. Network 500 may be the SDWAN, although examples are not so limited. For example, network 500 may be the SDWAN that is implemented for business communication among headquarter and/or branches. As such, each node may be assigned to a corresponding business communication point (e.g., headquarter and/or branches) such that each business point may be a communication end point and/or redistribution point. Each business point may include a network device that may be utilized as a basis for a logical node.

As illustrated in FIG. 5, a network may include example nodes 504-1, 504-2, 504-3, and 504-4 (e.g., collectively referred to as nodes 504) among which a data packet may be transmitted from one node to another node via various data paths. Data paths that may be enablable (e.g., adjustable to be available by a network controller) are established among the example nodes 504. For example, data path 544-1, 544-2, 544-3, 544-4, 544-5 can be established between node 504-1 and node 504-2, between node 504-2 and node 504-3, between node 504-3 and node 504-4, between node 504-1 and node 504-4, between node 504-1 and node 504-3, respectively, and between node 544-2 and node 504-4 (not shown).

Data paths illustrated in FIG. 5 may be a data path established via interfaces 106 and/or a virtual interface as described in connection with FIG. 1. That is, although an individual data path is illustrated between two nodes, there may be more than one data paths between two nodes. For the illustration purpose, therefore, each data path is a representative of those data paths that may be established between two nodes via interfaces 106.

Although examples are not so limited, each of data paths 544 may be assumed to have a total capacity of 100 megabits per second (e.g., Mbps). Stated differently, each of data paths 544 may be capable of transmitting data packets at a rate of, but no more than, 100 Mbps.

FIG. 5 illustrates those data path that are enabled (e.g., adjusted to be available) among those enablable data paths. The data path between node 504-2 and node 504-4 is not enabled. The data path between node 504-2 and node 504-4 may have been disenabled due to various reasons. For example, a policy associated with a factor (e.g., whose corresponding value is independent of a traffic state of the data path) such as cost, QoS, and/or SLA may have been violated. For example, the traffic state of the data path may indicate that enabling the data path would not increase a throughput. As such, the disenabled data path between node 504-2 and node 504-4 may not be utilized in this example, although the data path between node 504-2 and node 504-4 may be enablable at any time.

FIG. 5 illustrates, for example, three different communications. For example, in a first communication, node 504-1 may act as a source node to transmit data packets to a destination node, which can be node 504-3. For example, in a second communication, node 504-2 may act as a source node to transmit data packets to a destination node, which can be node 504-1. For example, in a third communication, node 504-4 may act as a source node to transmit data packets to a destination node, which can be node 504-3. Three data paths 544-1, 544-3, and 544-5 are utilized as direct data paths, as shown in FIG. 5. Those direct data paths illustrated in FIG. 5 indicates a source node and a destination node. For example, “direct (2-1)” on data path 544-1 indicates that node 504-2 is a source node for transmitting data packets to a destination node, which is node 504-1. For example, “direct (4-1)” on data path 544-4 indicates that node 504-4 is a source node for transmitting data packets to a destination node, which is node 504-1. For example, “direct (1-3)” on data path 544-5 indicates that node 504-1 is a source node for transmitting data packets to a destination node, which is a node 504-3.

As illustrated in FIG. 5, node 504-2 is utilized as an intermediate node for the first communication between node 504-1 and node 504-3. Stated differently, data paths 544-1, 544-2 established and enabled between node 504-1 and node 504-2, and between node 504-2 and node 504-3, respectively, may be utilized as an indirect data paths (e.g., “indirect (1-3)” as illustrated in FIG. 5) for the first communication. As such, as illustrated in FIG. 5, data packets for the first communication are transmitted on data path 544-1 and on data path 544-2 such that the data packets can be transmitted from node 504-1 to node 504-3.

In some examples, a rate at which data (e.g., data packets) are transmitted over indirect data paths may be limited and the limited rate can be equal to or less than a remaining capacity of the indirect data paths. For example, a remaining capacity of data path 544-1 is a 30 Mbps because data path 544-1 is being utilized as a direct data path (e.g., “direct (2-1)”) at a rate of 70 Mbps. As such, data path 544-1 may be utilized as an indirect data path (e.g., “indirect (1-3)”) for transmitting data packets from node 504-1 to node 504-3 at a rate of 30 Mbps or the less. Similarly, data path 544-2 is utilized as an indirect data path (e.g., “indirect (1-3)”) for transmitting data packets from node 504-1 to node 504-3 at a rate of 30 Mbps or the less.

As illustrated in FIG. 5, data path 544-3 is being fully utilized because data path 544-3 is utilized as a direct data path (e.g., “direct (4-3)” as illustrated in FIG. 5) for transmitting data packets from node 504-4 to node 504-3 at a rate of 100 Mbps. As such, node 504-4 may not be utilized as an intermediate node for communication between node 504-1 and node 504-3 because doing so would interfere with existing data transmission (e.g., “direct (4-3)”) of a direct data path.

In contrast, node 504-1 may be utilized as an intermediate node for communication between node 504-4 and 504-3, as illustrated in FIG. 5. For example, data paths 544-4 and 544-5 are being utilized as an indirect data path for transmitting data packets from node 504-4 to 504-3. A rate at which data packets are transmitted on data path 544-4 and 544-5 (e.g., “indirect (4-3)”) may be 10 Mpbs or less. For example, direct data path (e.g., “direct (1-3)”) for communication between node 504-1 and node 504-3 at a rate of 90 Mbps. As such, a remaining capacity of data path 544-5 is 10 Mbps, and the remaining capacity or the less can be utilized as an indirect data path (e.g., “indirect (4-3)”) for communication between node 504-4 and node 504-3. Although data path 544-4 is not being fully utilized in terms of a total capacity, data packets of “indirect (4-3)” may be transmitted on data path 544-4 at a rate of 10 Mbps or less that corresponds to a rate of data packets of “indirect (4-3)” being transmitted on data path 544-5. Therefore, a rate at which data packets are transmitted via indirect data paths may be lesser of remaining capacities of indirect data paths.

In some examples, network controller (e.g., network controller 102, 202, 302, and/or 402) may limit a number of available data paths utilized to transmit an individual data packet such that the data packet is transmitted from a source node to a second node via no more than two data paths. For example, as illustrated in FIG. 5, communication within a network (label?) is made by either a direct path and/or an indirect data path that is 1-hop path. By limiting a number of indirect data paths to be utilized, complexity in multipath adjustments may be reduced.

In some examples, a number of indirect data paths may be enabled to transmit data packets from a source node to a destination node while a direct path between the source node and the destination node may remain disenabled. Stated differently, the direct path may also be enabled/disenabled in the same manner as the indirect data paths may be enabled/disenabled responsive to various factors including, for example, a factor indicating a traffic state of a data path and/or a factor whose corresponding value is independent of the traffic state of the data path. For example, in transmitting data packets from a source node 504-1 to a destination node 504-3, data path 544-5 may be disenabled (e.g., not enabled) such that the data packets may be transmitted over indirect data such as data paths 544-1 and 554-2 without utilizing a direct data path, which is the data path 554-5.

It will be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

In the foregoing detailed description of the disclosure, reference is made to the accompanying drawings that form a part hereof, and in which is shown by way of illustration how examples of the disclosure may be practiced. These examples are described in sufficient detail to enable practice of the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 106 may refer to element 102 in FIG. 1 and an analogous element may be identified by reference numeral 202 in FIG. 2. Elements shown in the various figures herein can be added, exchanged, and/or eliminated to provide additional examples of the disclosure. In this regard, directional terminology, such as “front,” “rear” etc., is used with reference to the orientation of the Figure(s) being described. In addition, the proportion and the relative scale of the elements provided in the figures are intended to illustrate the examples of the disclosure, and should not be taken in a limiting sense.

What is claimed:

1. A network controller, including:
a processing resource; and
a memory resource storing machine readable instructions to cause the processing resource to adjust, responsive to a factor whose corresponding value is independent of a traffic state of a particular data path, an availability of the particular data path between two of the plurality of static nodes such that the plurality of static nodes are allowed to communicate within a network via the particular data path made available.

2. The network controller of claim 1, wherein each of the plurality of static nodes is a node that is static within the network such that an availability of each of a plurality of data paths among the plurality of static nodes is, by the controller, adjustable at any time the network controller is willing to.

3. The network controller of claim 1, wherein the controller is, if the particular data path is utilized as an indirect data path in transmitting a data packet, to limit a rate at which the data packet is transmitted via the particular data path such that the data packet transmitted over the available data path does not interfere with an existing data packet transmitted over the available data path.

4. The network controller of claim 3, wherein the particular data path is utilized as a direct data path in transmitting the existing data packet.

5. The network controller of claim 1, wherein the controller is to limit a number of indirect data paths utilized in transmitting an individual data packet from a source node to a destination node.

6. A network device, including:
a processing resource; and
a memory resource storing machine readable instructions to cause the processing resource to:
adjust, responsive to a factor whose corresponding value is independent of a traffic state of a data path between two static nodes of a plurality of static nodes of a network, an availability of the data path such that the data path adjusted to be available is utilizable as an indirect data path in transmitting a data packet of a plurality of data packets from a first static node to a second static node of the plurality of static nodes; and
limit a rate at which the at least one of the plurality of data packets is transmitted over the data path adjusted to be available such that the rate is equal to or less than a remaining capacity of the data path.

7. The network device of claim 6, wherein the plurality of static nodes are physically static in a network while a logical topology associated with the network is changeable responsive to the availability of the data path being adjusted.

8. The network device of claim 6, wherein the plurality of static nodes remain connected to each other such that an availability of each of a plurality of data paths among the plurality of static nodes is adjustable at any time unless a network infrastructure associated with the network changes.

9. The network device of claim 6, wherein:
the data path is one of a plurality of indirect data paths via which the one of the plurality of data packets is transmitted from a source node to a destination node; and
the remaining capacity is a remaining capacity of a particular one of the plurality of indirect data paths whose remaining capacity is less than those of others of the plurality of indirect data paths.

10. The network device of claim 6, wherein each of the plurality of static nodes includes a plurality of virtual interfaces and one of the plurality of static nodes is fully coupled to the all others of the plurality of static nodes via a corresponding one of the plurality of virtual interfaces.

11. The network device of claim 6, the factor is obtainable independently from communication with the plurality of static nodes.

12. The network device of claim 6, wherein the factor whose corresponding value is independent of the traffic state of the data path includes a cost associated with using each of a plurality of data path of the network.

13. The network device of claim 6, wherein the factor whose corresponding value is independent of the traffic state of the data path includes a quality of service (QoS) specification associated with the plurality of static nodes.

14. The network device of claim 6, including instructions to limit a number of available data paths utilized to transmit an individual data packet such that the data packet is transmitted from the first to the second of the plurality of static nodes via no more than two data paths.

15. The network device of claim 6, including instructions to adjust the availability of the data path between the two of the plurality of static nodes responsive to, in addition to the factor whose corresponding value is independent of the traffic state of the data path, a factor indicating a traffic state of the data path between the two of the plurality of static nodes.

16. A non-transitory machine-readable storage medium having stored thereon machine-readable instructions to cause a processor to:
enable a first data path between a source node of a plurality of static nodes and a destination node of the plurality of static nodes such that the first data path is adjusted to be available for communication between the source node and the destination node;
enable, responsive to a factor whose corresponding value is independent of a traffic state of each of a plurality of second data paths, at least two of the plurality of second data paths, wherein each of the plurality of second data paths is a data path that is different than the first data path; and
wherein enabled one of the plurality of second data paths is utilized as an indirect data path for transmitting a data packet from the source node to the destination node.

17. The medium of claim 16, including instructions to limit a rate at which the data packet is transmitted over the enabled one of the plurality of second data paths, wherein the limited rate is equal to or less than a remaining capacity of the enabled one of the plurality of second data paths.

18. The medium of claim 17, wherein the remaining capacity of the enabled one of the plurality of second data paths corresponds to a total capacity of the enabled second data path less a capacity of the enabled second data path being utilized.

19. The medium of claim 16, wherein the plurality of second data paths are enablable responsive to determining that a policy associated with the factor remains non-violated.

20. The medium of claim 16, wherein the plurality of second data paths are prohibited from being enabled responsive to determining that a policy associated with the factor is violated.
